(19) United States
(12) Patent Application Publication
(10) Pub. No.: US 2006/0116943 A1
(43) Pub. Date: Jun. 1, 2006

(54) Method to determine price inflections of securities

(76) Inventor: Pascal Willain, Waterloo (BE)

Correspondence Address: John A. Monocello III, Esq.;Cohen & Grigsby, P.C., 15th Floor, 11 Stanwix Street, Pittsburgh, PA, 15222, US

(21) Appl. No.: 11/021,877

(22) Filed: Dec. 22, 2004

Related U.S. Application Data
(60) Provisional application No. 60/631,948, filed on Nov. 30, 2004.

(51) Int. Cl. G06Q 40/00

(52) U.S. Cl. 705/35

(57) ABSTRACT

The present invention provides a method to detect buying or selling activities of large market players of a given equity, compared to the activity of smaller players. For a set of consecutive trading sessions, the method analyses only trading data (open/high/low/close/volume) aggregated into regular intervals such as one-minute, two-minutes or five-minute trading data. The method considers only time intervals corresponding to price inflections, i.e. for which the closing price was different from the previous time interval. The method further analyses the volume of said time intervals and calculates the effective volume that was responsible for a price inflection. The method then separates the effective trading volumes related to the said time interval into large and small size volumes and plots the evolution of the said volume sizes on a graph. Analysis of trend divergence between large and small size volume flow trends allows detection of the said buying and selling activity by large or small market players.

### CLAIM OF PRIORITY

This invention claims the benefit of U.S. Provisional Application No. 60/631,948 filed on Nov. 30, 2004.

### FIELD OF THE INVENTION

This invention relates to methods for analysing securities information, and in particular, to such methods involving the monitoring of stocks on the Internet.

### BACKGROUND OF THE INVENTION

The dissemination of information through the Internet has made stock trading accessible to any retail investor at low cost. The number of market players who can respond on-line is growing, which results in a better equilibrium between the bid and the ask. However, the use of trend technical-analysis tools based on minute-by-minute data changes increases volatility. Indeed, these tools induce market players to react together to changes in trends, generally increasing the change and thus volatility. A given equity will therefore move between stability and instability. Therefore, there is a need for, and thus the present invention provides for a method to analyse consecutive changes in small price inflections that modify the equilibrium between bid/ask of a certain security, allowing an underlying broader trend change for the given security to be detected.

The present invention also provides a method to detect some types of controlled accumulation or distribution by large players in the stock market, allowing retail investors to benefit from the changing trend before it appears in the prices. Indeed, retail investors have to compete against large market players such as institutions and hedge funds who have professional tools and financial means to play the markets. These large market players are usually viewed as trendsetters: whenever they buy or sell, the stock price has a potential to quickly rise or fall. Large players tend to manipulate the market. That is, large player's stock accumulation or distribution must be accomplished in a controlled way, in order to avoid a price surge during their accumulation period or a price decline during their distribution period. The present invention provides a method to detect such market manipulations by large market players.

One well-known method to analyse the trend change of a stock is to calculate the money flow at each time interval, using a standard formula such as the Larry Williams formula. Such method is weak, because it does not take the price inflections into consideration or the difference in behaviour depending on the size of the volume involved at each time interval.

Another well-known method is to analyse each transaction that is taking place, and separate them between bid/ask. The transactions at the bid being defined as sellers and the transactions at the ask as buyers. The analysis of the balance between transactions at bid and transactions at ask offers a clue regarding an underlying trend change. By combining this analysis with the analysis of the size of the orders that were placed, it is possible to define if the balance change was due to large or small players. One problem of this method is that it does not relate the size of the bid/ask proportion to price inflections. Therefore, it is not possible to see manipulation from large players for example when small sales are made at the bid to push the price down, while some large buys are made at the ask with as a consequence to push the prices up. Another important problem of that method is that it is based on real transaction and order data, which are not readily available to retail investor on a free basis. The claimed method is based on a set of time intervals data (for example minute-by-minute), which are aggregate of all the transactions that were performed during a time interval. Such data is available free of charge on many Internet sites.

### SUMMARY OF THE INVENTION

The claimed method is structured on the theory that large players are more likely than retail players to have superior information. Large players will also generally have a stronger impact on the price movements of a given stock, since they usually place larger orders. The inventor has found that that since large players need to fill larger orders than retail players, during a trading session, large market players' activity is more likely than retail players' activity to incur price changes from one time intervals to the next.

Small closing price changes between one time interval and the next constitute price inflections. The inventor has found that consecutive price inflections in the same direction (price increase or price decrease) have the potential to incur trend changes on a given equity. The inventor also notes that since on-line technical tools measuring on balance volume (“OBV”), MACDH, RSI, etc . . . . usually operate at fixed time intervals of one minute or five minutes, the monitoring of price inflections occurring at regular one minute intervals is preferable to detect trend changes.

Monitoring these price inflection points in relation to volume enables the action of large players to be distinguished from those of retail players. The claimed method helps to identify price manipulations used by large players to sell or buy large volumes over a certain period of time without affecting the price of a stock.

To be used, the claimed method preferably is applied to historical data that must be available at regular time intervals (TI) (1 minute, 5 minutes, etc.), values of which include Date, Time, Open, High, Low, Close, Volume. Working on aggregate one minute data allows aggregation of all the small transactions that took place during one minute, enabling the comparison of consecutive price/volume changes at one-minute time intervals. It is preferable to leaving the time interval as a constant value because doing so allows a good comparison between large and small volume sizes.

The invention enables the monitoring of the volume that was necessary to incur a price inflection at each Time Interval during a number of consecutive trading sessions. Such volume is referred to as the effective volume (“EV”).

The claimed method separates the EV between large volume sizes (“LVS”) from small volume sizes (“SVS”) and calculates the volume flow (“VF”) for each type of effective volume size (LVS or SVS).

### BRIEF DESCRIPTION OF DRAWINGS

FIG. 1 is explanatory of the process by which the inventor arrived at the present invention.

FIG. 2 is a flow chart for the calculation of Effective Volume according to the present invention.

FIG. 3 shows an example of the results of Effective Volume calculated according to the present invention.

FIGS. 4A and 4B depict the volume flow of calculating separation volume based on the total analysis period.

FIGS. 5A and 5B depict the volume flow of calculating separation volume based on the preferred embodiment of the invention.

FIG. 6 depicts an example of volume flow calculated according to the present invention.

FIGS. 7-9 show examples of the invention being applied to real trading session data. FIG. 7 shows time on the X-axis and price on the Y-axis. FIG. 8 shows time on the X-axis and Effective Volume on the Y-axis. FIG. 9A shows time on the X-axis and Large Size Volume Flow on the Y-axis. FIG. 9B shows time on the X-axis and Small Size Volume Flow on the Y-axis.

FIG. 10 is a flow chart for calculating separation volume according to the present invention.

FIG. 11 is a flow chart to separate Small Volume Size (SVS) from Large Volume Size (LVS) based on the Effective Volume and the Separation Volume calculated through FIG. 2 and FIG. 10.

### DETAILED DESCRIPTION OF THE PRESENTLY PREFERRED EMBODIMENT OF THE INVENTION

In order to properly understand the disclosure of the claimed invention, the inventor has described certain terms herein in the following paragraph. While the inventor describes the following terms, the inventor in no way intends to disclaim the ordinary and accustomed meanings of the terms.

Time Interval (“TI”) is defined as the smallest time interval that is used in the claim method. Preferably, TI is one minute. Trading Session (“TS”) is defined as a period of time during which trading of a specific stock is not halted or interrupted. Preferably, a trading session is a trading day. Price Interval (“PI”) is defined as the lowest possible stock price change (increase or decrease) that can be monitored from one time interval to the next, during a specific trading session. Preferably, PI is set at US$ 0.01. The Analysis Period (“AP”) is defined as one or more concomitant trading sessions. An Inflection Point (“IP”) related to the price of a security is a small closing price increase or decrease between one time interval and the next, preferably of an amplitude at least equal to the PI. A Volume Size (“VS”) related to a given TI refers to the total number of shares that were traded during that TI. An Effective Volume Size (“EV”) related to a given TI refers to the total number of shares that were responsible for the price inflection. A Large Volume Size (“LVS”) is defined as an EV whose total number of shares is equal to or higher than the Separation Volume. A Small Volume Size (“SVS”) is defined as an EV whose total number of shares is lower than the SV. The Separation Volume (“SV”) is defined as a given number that separates LVS from SVS.

The method comprises the step of calculating the volume responsible for the price inflection. This volume is referred to as the EV. The inflection points are important in the evaluation of trend changes. In a novel step over the prior art, this invention considers only TI that exhibit a price inflection when calculating the volume responsible for price changes, i.e., EV. A price inflection leading from one Time Interval to the next can either be positive (price increase) or negative (price decrease).

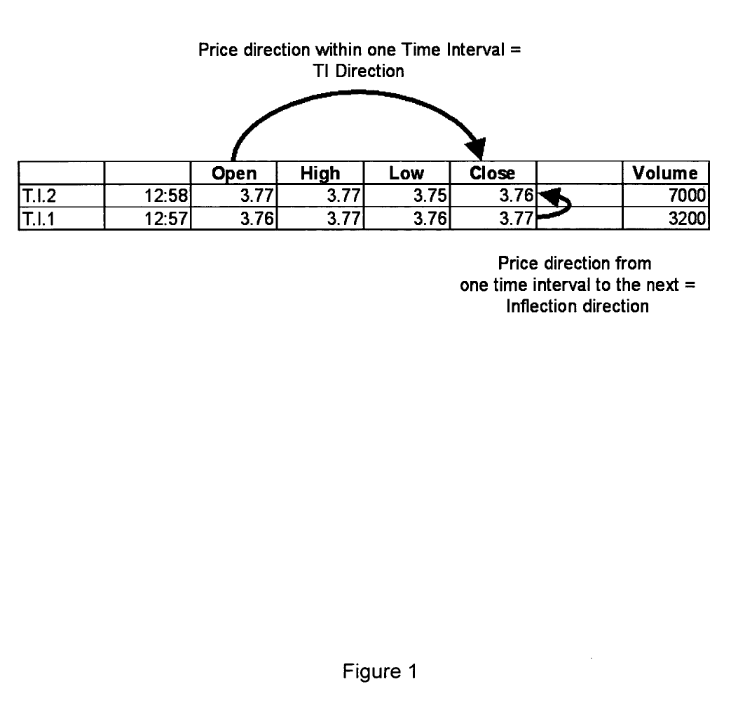

FIG. 1 is illustrative of the process by which the inventor arrived at the claimed invention. In considering data from a trading session, FIG. 1 shows that inflection direction was negative since the closing price on T.I. 2 was lower than the closing price of T.I. 1. In the prior art, the standard method of Money Flow analysis developed by Larry Williams in 1972 would take the volume of T.I. 2 weighted by the proportion between “Open-Close” and “High-Low” when trying to evaluate the volume of shares that were responsible for the price change during T.I. 2. The succession of these volume calculated period by period constitutes the Larry Williams method

Larry Williams' formula weights the volume of the current period by the difference between opening and closing prices of the period compared to the period's High-Low range:
((Openᵢ−Closeᵢ)/(Highᵢ−Lowᵢ)).

In a novel step, the inventor has found that it is preferable to add PI on both sides of the fraction to take into account the fact that if a stock's range is between 10.00 and 10.01, some shares were traded at 10.00 and some at 10.01, making it a distance of two price intervals (0.02), even if the mathematical difference is only one price interval (0.01).

The modified Larry Williams formula thus became:
(ABS(Openᵢ−Closeᵢ)+PI)/(Highᵢ−Lowᵢ+PI), where
Openᵢ=Opening price corresponding to Time Interval (i): Tiᵢ
Closeᵢ=Closing price corresponding to Time Interval (i): TIᵢ
Highᵢ=High price corresponding to Time Interval (i): TIᵢ
Lowᵢ=Low price corresponding to Time Interval (i): TIᵢ
PI=Price Interval (usually US$0.01).
ABS=Absolute value
Note that because of the “ABS” use, the above modified Larry Williams formula always gives positive results. To calculate a volume flow based on that formula, the results need to be multiplied by −1 in case of Closeᵢ>Openᵢ

However, this formula does not take into account the problems of opening gaps: the Open of T.I. 2 can either be lower than or higher than the Close of T.I. 1. Thus, since the claimed method only considers the volume responsible for a price inflection, the inventor has found that in the modified Larry Williams formula, the invention should utilize the Close of the previous TI instead of the Open of the current TI.

Therefore, it is desirable to use the following claimed method to determine EV. The formula is as follows:
(ABS(Closeᵢ₋₁−Closeᵢ)+PI)/(Highᵢ−Lowᵢ+PI), where
Closeᵢ₋₁=Closing price corresponding to Time Interval (i−1): TIᵢ₋₁
Closeᵢ=Closing price corresponding to Time Interval (i): TIᵢ
Highᵢ=the maximum value of Highᵢ and Closeᵢ₋₁
Lowᵢ=the minimum value of Lowᵢ and Closeᵢ₋₁
PI=Price Interval (usually US$0.01).
ABS=Absolute value
To calculate a volume flow based on the above formula, the result needs to be multiplied by “−1” in case of Closeᵢ>Closeᵢ (The result needs to be multiplied by the direction of the Price Inflection as explained below in paragraph 0049)

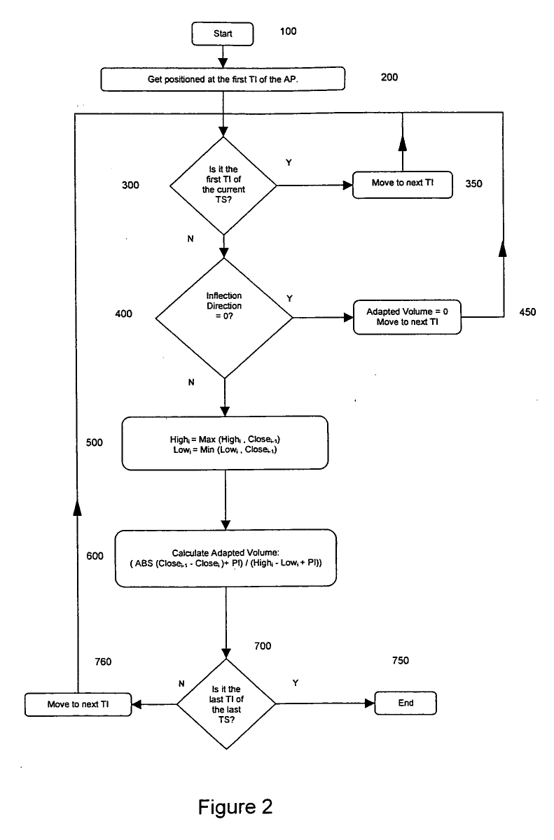

FIG. 2 is a flow chart of the calculation of EV according to the present invention. The method comprises positioning at the first TI of the AP as shown in step 200. Another step in the method is to determine whether the TI is the first of the current TS, as shown in step 300. Step 350 shows that if the TI is the first TI of the trading session that the method comprises moving to the subsequent TI. This is one way that the invention deals with pricing gaps, that may be present from the close of TS to the opening of a separate TS. At step 400, the inflection direction is determined if the inflection direction is zero, a value of zero is assigned as the EV (as shown in step 450). If the inflection direction is not zero, then steps 500 and 600 show that the calculation of the EV is as described above. The step of determining an inflection direction value further comprises assigning the inflection direction value as +1 if C>C′, as −1 if C<C′, and as 0 if C=C′ 700, 750 and 760 shows that if the TI is the last TI of the TS, the method concludes. If not, the method proceeds.

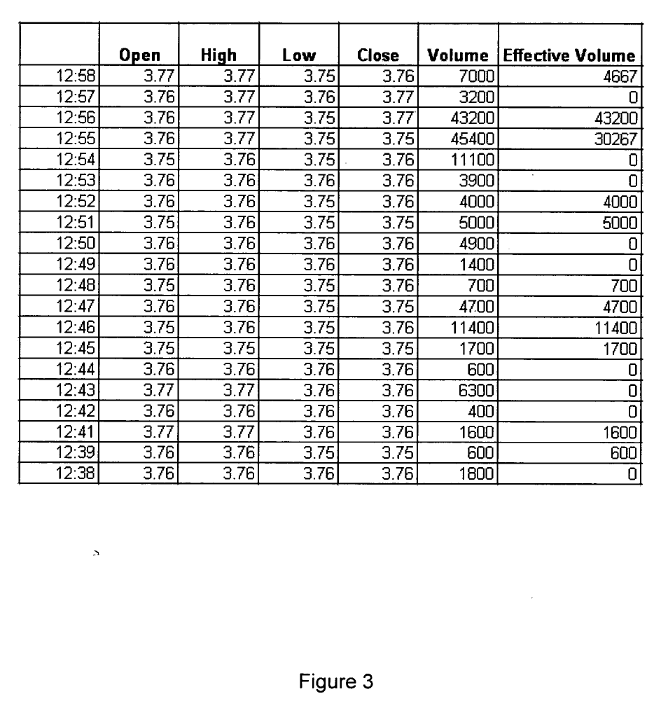

FIG. 3 shows an example of EV calculated according to the present invention.

As shown in FIG. 3, a set of effective volume sizes results upon completion of the method steps described above. As stated above, the effective volume sizes are the volumes that are responsible for a price inflection.

The method is preferably based on the separation of large vs. small EV's (LVS vs SVS), therefore, it is important to properly describe LVS and SVS. The invention provides a process to separate between LVS and SVS that leaves enough traded shares belonging to each group, so as to increase the statistical validity of the calculation.

The method comprises considering each EV traded during a specific time interval to which an inflection point was associated. If the EV traded during that specific time interval is larger or equal to SV, the volume traded during that interval is determined to be a “Large Volume Size” (LVS). Conversely, if the EV traded during that specific time interval is smaller than SV, the volume traded during that interval is determined to be a “Small Volume Size” (SVS).

Preferably, the method provides that the number of shares belonging to the LVS group be reasonably close to the number of shares belonging to the SVS group. It is preferable that the ratio between each group of shares (LVS vs. SVS) not be wider than 30%-70% of all the shares traded.

In instances where the AP covers more than one trading session, the method provides that the separation volume is separately calculated for each trading session. Such a method is referred to as the Dynamic Separation Volume (DSV) method. Benefits of the DSV include avoiding one-day spikes in trading volume since these spikes incur statistical noise on the separation volume for the total of the analysis period. If the separation volume was calculated on the total analysis period, on average many trades occurring during the one-day spike would be labeled as LVS, while on average, many trades occurring out of the one-day spike would be labeled as SVS. Using the DSV method for effective volume size separation is therefore preferable to account for volume spikes from one trading session to the next.

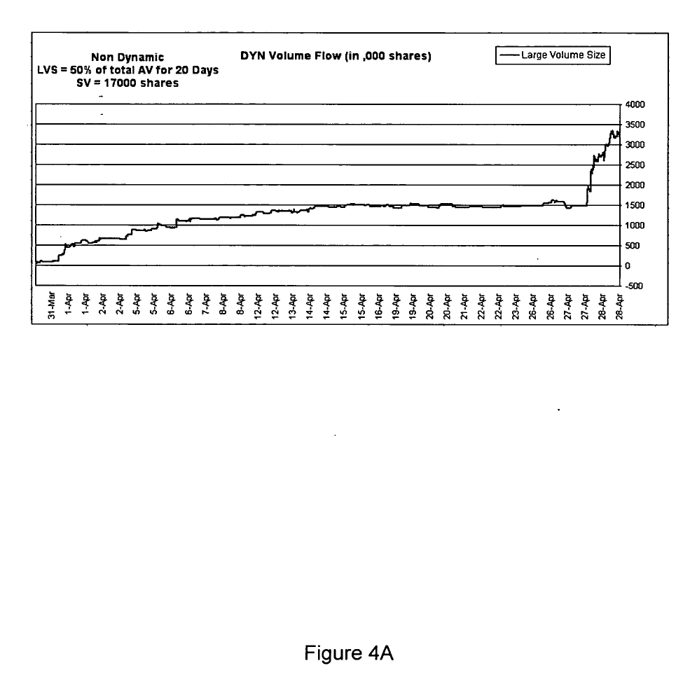

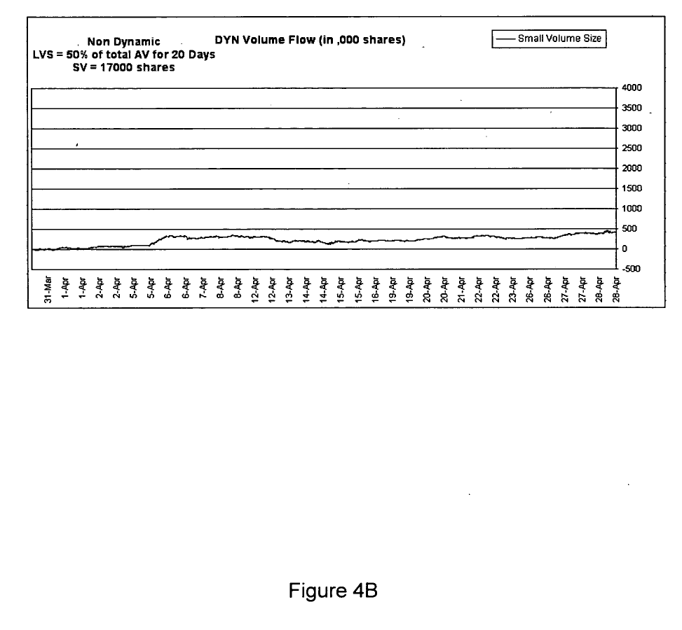

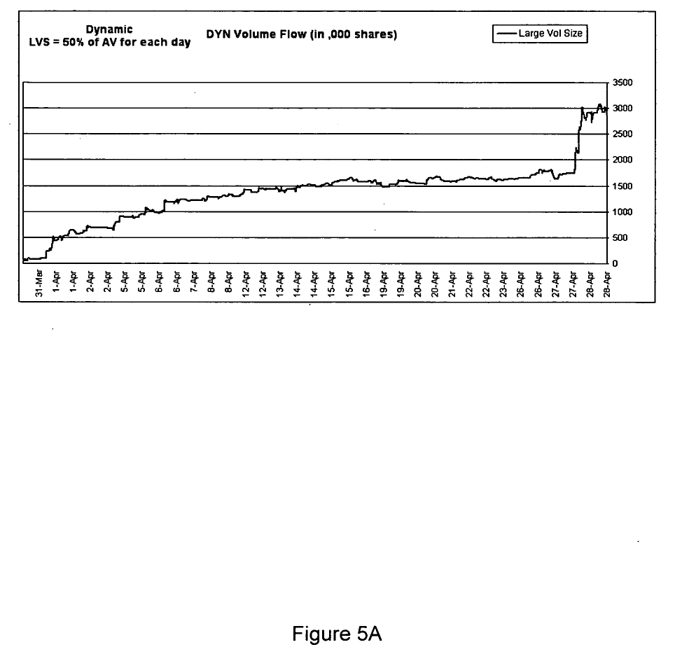

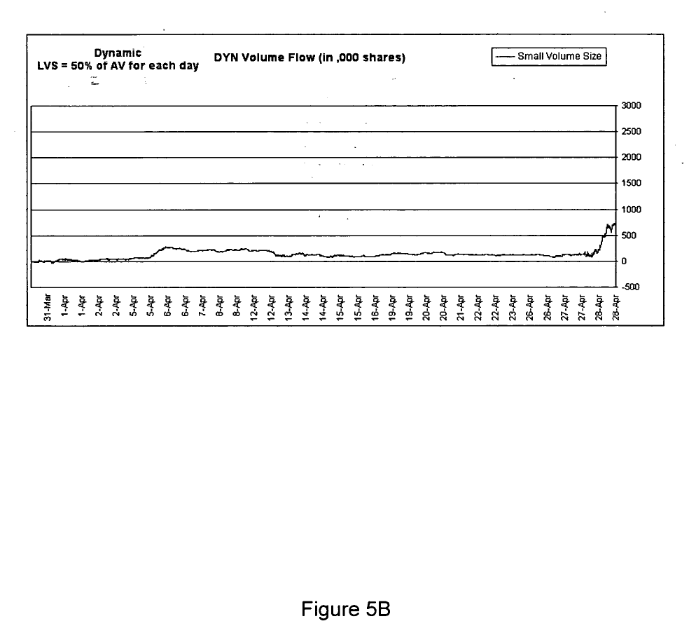

FIGS. 4A and 4B show the LVS and SVS representation using a separation volume size (SV) calculated on the total analysis period of 20 days, while FIGS. 5A and B show the LVS and SVS representation using separation volume size dynamically calculated for every trading session of the analytical period. It can be seen in FIGS. 5A and B that DSV method leads to better representation of the LVS accumulation before the run of April 28 than that of the method shown in FIGS. 4A and 4B.

The method also eliminates the noise generated by very large blocks of shares being transferred through a public exchange by a Specialist or Market Maker to or from his client. The invention preferably defines a large block as any block that constitutes over 10% of the whole volume of shares traded during the trading session, said block not incurring significant price change during the specific time interval of occurrence. A significant price change is one that can be set by the user of the method. However, the inventor presently prefers to determine whether a price change is significant by determining if the shares traded during one time interval is higher than X* the average of the total number of shares traded during the last Y trading sessions, where X preferably is equal to 0.1 and Y is preferably equal to 10. The next step in the presently preferred method is to determine whether the high-low for the time interval during which a very large block was traded is less than or equal to 2 PIs. If so, the trade should be eliminated from the calculation. Such very large trade action can have consequences on both the SV and the AV Volume Flow calculation that is explained below.

While both the Dynamic Separation Method and the elimination of noise from very large blocks greatly improve the invention, they are optional. Such methods are not essential for the operation of the invention, especially when there is neither volume spike nor very large blocks, during a trading session, which represents the great majority of the cases.

The invention represents TSₖ as an indexed variable representing all the Trading Sessions included in the AP. TIᵢ is an indexed variable representing all the TI's corresponding to a price inflection. EVᵢ is an indexed variable representing the EV traded during interval TIᵢ. EV_{tot,k}, is the total EV corresponding to price inflections and traded during TSₖ. It is the sum of all EVᵢ:

$${EV}_{tot , k} = {\sum }_{i = 1}^{t} ( {EV}_{i} ) ;$$

t=the total number of TI during TSₖ
SVₖ is the Separation Volume related to TSₖ. SVₖ is preferably defined as the volume to be used to separate SVS from LVS, with the objective that

$${\sum }_{i = 1}^{t} ( {SVS}_{k , i} ) be close to {AV}_{tot , k} / 2$$

In order to test the influence of SV definition on the Effective Volume Size Trend Analysis, the following formula can also be used, X being an external parameter to be fixed at the time of the analysis:

$${\sum }_{i = 1}^{t} ( {SVS}_{k , i} ) be close to {\sum }_{i = 1}^{t} ( {LVS}_{k , i} ) * X$$

It should be noted that the total effective volume of TSₖ is equal to the sum of the SVS and LVS.

$${AV}_{tot , k} = {\sum }_{i = 1}^{t} ( {SVS}_{k , i} ) + {\sum }_{i = 1}^{t} ( {LVS}_{k , i} )$$

Effective Volume Size Trend Analysis is the combination of the first two steps described above. Effective Volume Size Trend Analysis examines the effective volume necessary to make the price change between two consecutive TI's, examines the direction of the change and if the volume involved belonged to SVS or LVS groups.

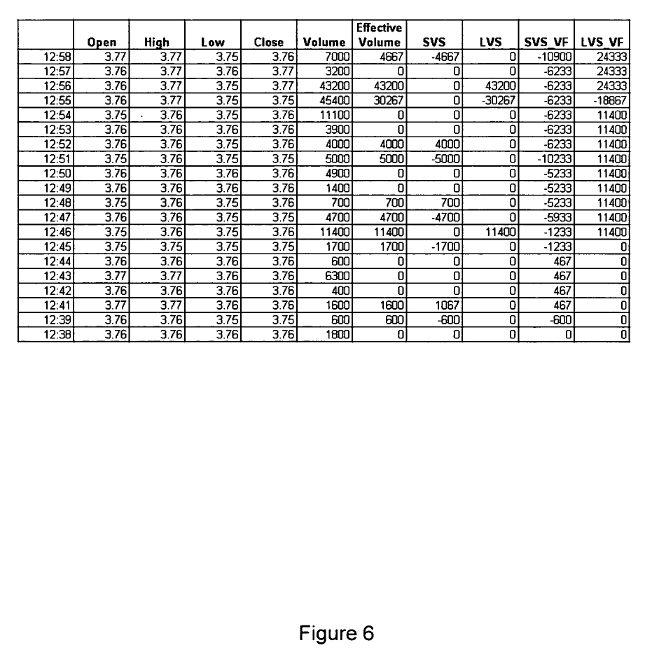

FIG. 6 provides an example. The separation volume is what separates the Effective Volume at each trading Interval that is rated as Small Size from the one that is rated as Large Size. Each of these groups will be analysed separately below. It is therefore critical to select the separation volume correctly.

Considering FIG. 6, it can be seen that EV has been calculated for each time interval. Note that FIG. 6 only represents a very small part of a trading day. However, to study a trend, it is necessary to analyse several trading days (trading sessions or TS).

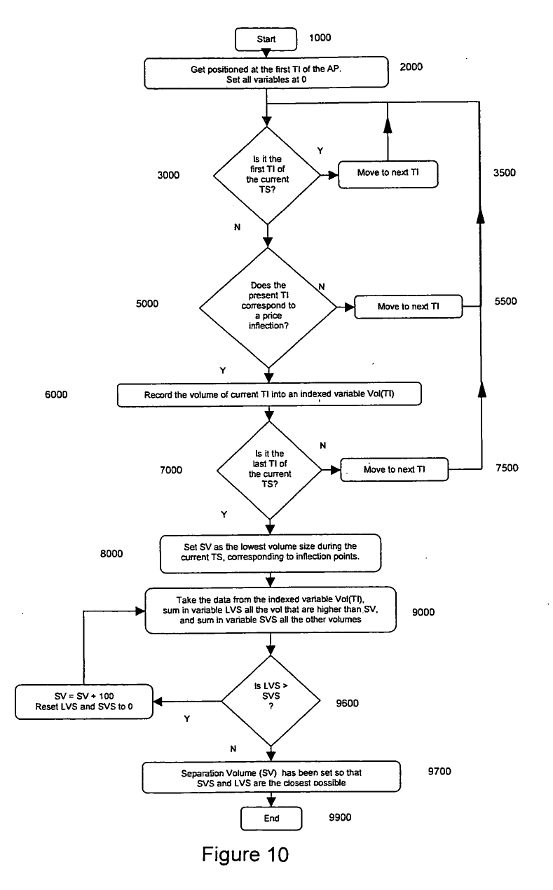

A presently preferred calculation separation volume is shown in FIG. 10, at steps 8000, 9000, 9500, and 9600, but the skilled artisan will appreciate that any calculation that considers the total effective volumes and sets the SV such that said SV will separate LVS and SVS into a ratio between 30% to 70% will suffice.

The presently preferred calculation is as follows. FIG. 10 shows that at step 2000 the method positions at the first TI of the AP and that all variables are set to zero. As shown in step 3000, another step is to determine whether the TI is the first TI of the current TS. If it is, then the method comprises moving to the next TI (as shown in step 3500). If it is not the first TI, the method comprises moving to step 5000 to determine if the present TI corresponds to a price inflection. If it does not, then the EV of the current TI is recorded into an Indexed Variable Vol(TI) as shown at step 6000. Next, the method determines whether the TI is the last TI of the current TS (shown at 7000). If it is not, then the method is to move on to the next TI as shown in step 7500. If it is, step 8000 is to set the SV as the lowest volume size during the current TS, which corresponds to inflection points. At step 9000, the data for the variable Vol(TI) is taken, the variable LVS that are higher than the SV are summed, and all other volumes along with variable SVS are summed. If the LVS is greater from the SVS (step 9600), the SV is set equal to the SV+100, the LVS and SVS variables are set to zero, and step 9000 is repeated. If the LVS is less than the SVS (step 9600), then the separation volume has been properly set, as shown in step 9700.

An Effective Volume Flow formula is used to calculate the Volume Flow on large volume sizes (“Large Size Volume Flow” or “LVS_VFᵢ”) then on small volume sizes (“Small Size Volume Flow” or “SVS_VFᵢ”) also referred to as “Large Blocks Money Flow” and “Small Blocks Money Flow” respectively, simply by adding for each category of Volume Sizes the Effective Volume:

LVS_VFᵢ=LVS_VFᵢ₋₁+LVSᵢ*Inflection Direction

SVS_VFᵢ=SVS_VFᵢ₋₁+SVSᵢ*Inflection Direction

For i=1, LVS_VFᵢ=0, SVS_VFᵢ=0

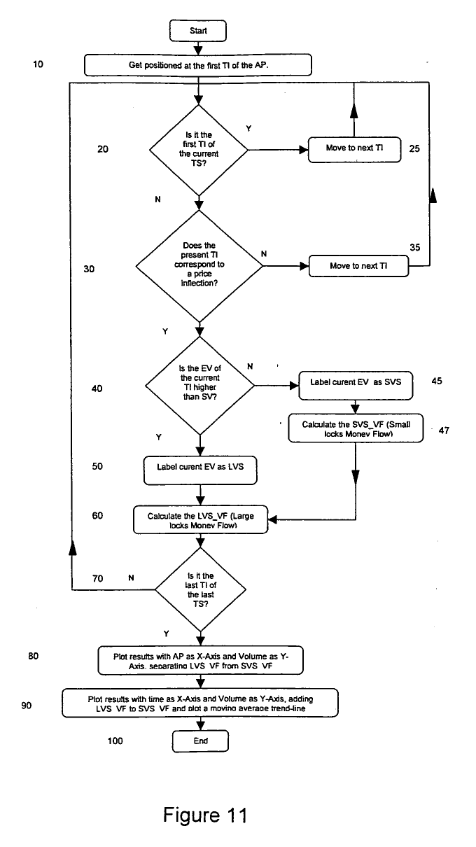

As shown in FIG. 11, in another embodiment of the invention, the method comprises positioning at the first TI of the AP (step 10). The method further comprises determining whether the TI is the first TI of the current TS, as shown in step 20. If it is, the method moves to the next TI (step 25). If the TI is not the first TI of the current TS, step 30 shows that the next determination is whether the present TI corresponds to a price inflection. If it does not, the method moves to the next TI (step 35). If the present TI does correspond to a price inflection, then the method proceeds to step 40. Step 40 is to determine if the EV of the current IT is higher than the SV. If it is not higher, then the EV is labeled as SVS (step 45) and the next step is to calculate the Small Blocks Money Flow (SVS_VF) by the “SVS_VFi” formula mentioned above. If the EV of the current TI is not higher than the SV, then the current volume is labeled as LVS (as shown in step 50), and the Large Blocks Money Flow or “SVS_VFᵢ” is calculated by the formula method above. At step 70, a determination is made as to whether the TI is the last TI of the last TS. If it is not, the process iterates. If it is, step 80 is to plot the results with the AP as the X-axis and volume as the Y-axis separating Large Block Money Flow from Small Block Money flow. Step 90 is to plot the results with the time as the X-axis and Y-axis, adding Large Block Money Flow to Small Block Money flow, and to plot a moving average trend line.

FIG. 6 shows the labelling of SVS and LVS on a separation volume of 10,000 shares. The resulting Volume flow is calculated, separating SVS from LVS. As an example of Effective Volume Flow calculation, FIG. 6 shows that with a separation volume for the whole trading session set at 10,000 shares, during the trading activity that took place between 12:38 and 12:58,
The price did not change (opening at 3.76 at 12:38 and closing at 3.76 at 12:58)
The effective volume flow of SVS was negative at −10900, while the effective volume flow of LVS was positive at 24333. This indicated a possible accumulation of shares by large players that took place during that period of time.

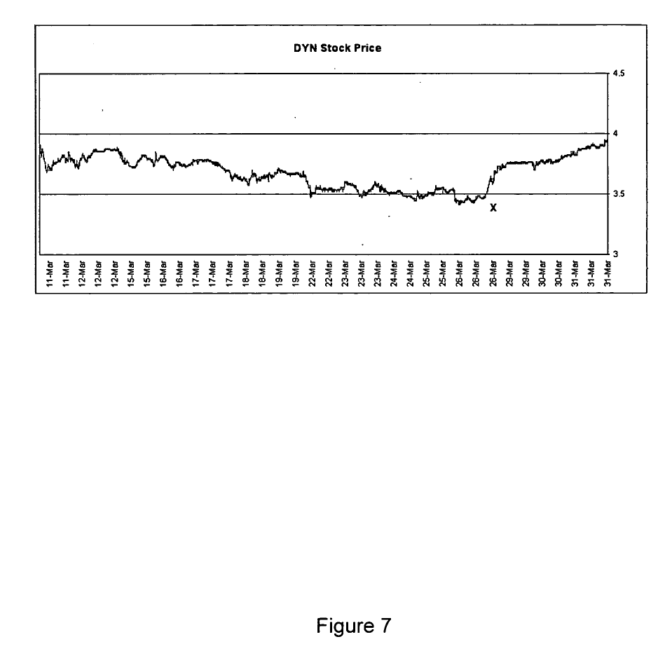

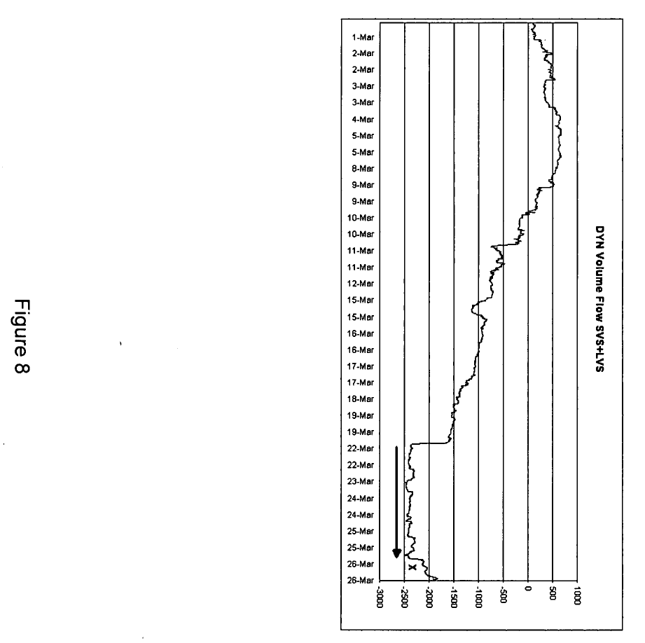

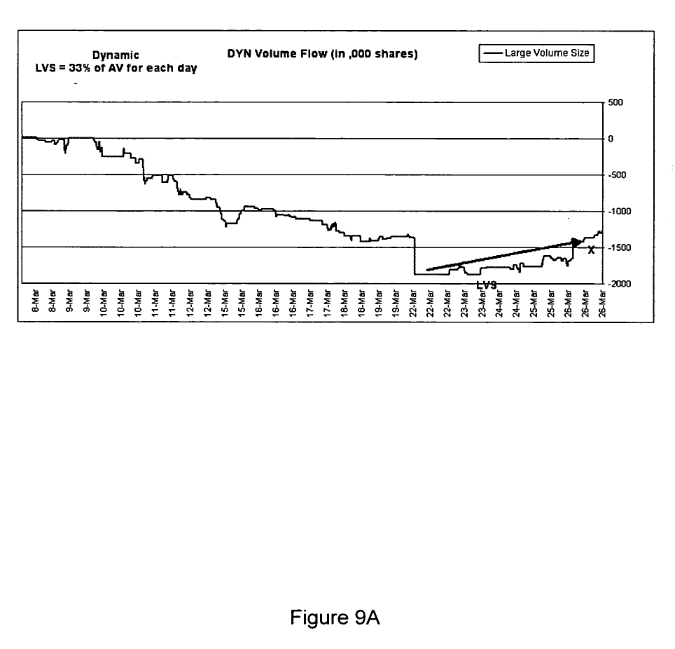

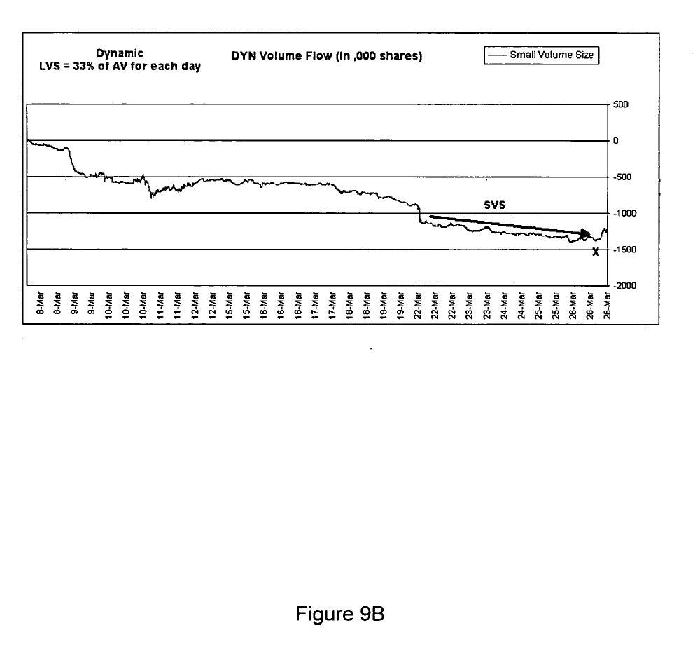

FIG. 7-9A and B show how valuable this invention can be. Indeed, FIG. 8 shows a reversal in price that occurred at point “X”, on March 26. Buying on March 26 would have been too late to catch the entire upswing. A Volume Flow analysis that did not separate SVS from LVS would have led to no specific conclusion, as seen on FIG. 9, since the trend was flat. However, FIG. 9, which represents the Volume Flow separately plotted for large and small volume sizes clearly show a trend divergence between March 22 and March 25 between SVS (Selling pressure) and LVS (Buying pressure), indicating a change of trend. This graph shows that Large Sizes were moving ahead of price and thus set the trend. Buying during that period would have been very beneficial.

In alternate embodiments, the inventive method can be embodied in a system. In one embodiment, the system is a computer system, that contains a processor unit, main memory, and an interconnect bus. The processor unit may contain a single micro processor, or may contain a plurality of microprocessors for configuring the computer as a multi-processor system. The main memory stores, in part, instructions and data for execution by the processor unit. If the method is implemented in software, the main memory stores the executable code when in operation. The main memory may include banks of dynamic random access memory as well as high speed cable memory.

The computer system may further include a mass storage device, peripheral devices, portable storage medium drives, input control device, a graphics subsystem, and an output display. The computer system may be connected through one or more data transport means. For example, the processor unit and the main memory may be connected via a local microprocessor bus, and the mass storage device, peripheral devices, portable storage medium drives, graphics subsystem may be connected via one or more input/output (I/O) busses. The mass storage device, which may be implemented with a magnetic disk drive or an optical disk drive, is non-volatile storage device for storing data and instructions for use by the processor unit. In the software embodiment, the mass storage device stores the information software for loading to the main memory.

The input control device(s) provide a portion of the user interface for a user of the computer system. The input control devices may include an alpha numeric keypad for inputting alphanumeric and other key information, a cursor control device, such as a mouse, a trackball a stylus, or cursor direction keys. In order to display textual and graphical information, the computer system contains the graphics subsystem and the output display. The output display may include a cathode ray tube display or a liquid crystal display. The graphics subsystem receives textual and graphical information and processes the information for output to the output display. The components contained in the computer system are those typically found in general purpose computer systems, and in fact, these components are intended to represent a broad category of such computer components that are well known in the art.

As explained above, the invention has several useful applications, one of which is as a utility in a market manipulations analysis. A standard manipulation occurs when a large market player wishes to sell a large volume of a given equity without incurring a price decrease. This implies that the market player will have to sell his shares at the bid, limiting the volume he places for sales to the size to the volume of the bid. Taking out the bid will lower the price by one tick (minimum price change). The market player will then have to place a small buying order at the ask to increase the price by one tick. He will wait for the bid volume to increase again, and will continue this operation.

For an equity mainly owned by institutions, such a move may indicate long-term trend changes since institutions have longer investment time spans than retail investors.

For an equity mainly owned by retail investors, if the number of traded shares is sufficient, such a market manipulation could indicate the work of a hedge fund. This could result in a short-term trend change, since hedge funds tend to have shorter investment time spans than institutions.

In both cases, the claimed method recognises that large market players are active in a given direction or another.

The invention is also useful as a tool for trading range analysis. In a trading range, the price of an equity will move between defined borders for a certain number of days. The trading range usually ends with a new upward or downward trend. The Volume Flow analysis during a trading range allows us to determine if large size volume or small size volume are responsible for price inflections. The trading range will have high probability of breaking out in the direction of the Large Size Volume flow.

The invention can also confirm trends. If both SVS and LVS trend in the same direction as the price trend, this confirms the price trend.

Further, the invention can indicate that a trend reversal is imminent. During an uptrend, if the LVS trend in the opposite direction to the price trend, the reliability of the price trend should be questioned: a trend reversal could be on the way.

Still further, since data can be fed on-line, our method also works well for day trading indication.

While certain applications have been described above, the skilled artisan will appreciate that there may be other applications to which the invention is well-suited.

1. A method to determine the effective volume of shares responsible for trend change associated with a security, said method comprising the steps of:
a. selecting an analysis period, said analysis period comprising at least one trading session;
b. selecting a first time interval in said trading session, said first time interval comprising security information, said security information comprising an opening price value, a closing price value, a high price value, a low price value, and share volume value;
c. selecting a second time interval in said trading session, said second time interval comprising security information, said security information comprising an opening price value, a closing price value, a high price value, a low price value, and a share volume value;
d. selecting a price interval value;
e. determining an inflection direction value;
f. calculating an effective volume multiplier, if said inflection direction value is not equal to zero, said step of calculating an effective volume comprising the steps of:
i. calculating the effective volume multiplier as follows:
[(ABS(C′−C))+PI]/(H−L+PI),
ii. if said inflection direction value is equal to zero, assigning zero as the effective volume multiplier;
wherein C′ equals said closing value of said first time interval, C equals said closing value of said second time interval, PI equals said selected price interval value, H equals the maximum value of said high price value of said second time interval and said closing value of said first time interval, L equals the minimum value of said low price value of said second time interval and said closing value of said first time interval; and
f. multiplying said effective volume multiplier by said share volume value to obtain said effective volume.

2. The method of claim 1 wherein said step of determining an inflection direction value further comprises assigning the inflection direction value as +1 if C>C′, as −1 if C<C′, and as 0 if C=C′.

3. The method of claim 1 wherein said step of selecting a first time interval further comprises:
a. determining whether a time interval is the initial time interval in said trading session; and
b. selecting a subsequent time interval if said time interval is an initial time interval.

4. The method of claim 1 wherein said step of selecting a second time interval further comprises selecting a time interval that is subsequent to said selected first time interval.

5. The method of claim 1 further comprising:
a. determining whether said selected first time interval is the last time interval of said trading session; and
b. concluding said method if said selected first time interval is the last interval.

6. The method of claim 1 wherein said trend change is a price change.

7. The method of claim 1 further comprising the step of assigning a separation volume value.

8. The method of claim 2 or 7 further comprising the steps of:
a. if said effective volume is not equal to zero, identifying said effective volume as a large volume size if said effective volume is greater than or equal to the separation volume value; and
b. if said effective volume is not equal to zero, identifying effective volume as a small volume size if said effective volume is less than the separation volume value.

9. The method of claim 8 wherein said separation volume value is assigned such that the ratio of said large volume size to said small volume size is from about 0.42 to 1.

10. The method of claim 8, wherein said separation volume value is assigned such that the ratio of said small volume size to said large volume size is from about 0.42 to 1.

11. The method of claim 7 wherein said analysis period comprises a plurality of trading sessions and said step of assigning a separation volume is separately calculated for each trading session in said plurality.

12. The method of claim 11 wherein said plurality of trading sessions comprises a plurality of consecutive trading sessions.

13. A system to determine the effective volume of shares responsible for trend change associated with a security, said system comprising:
a. a storage medium for storing instructions;
b. an input device for receiving input;
c. a processor unit operable to process said input and to use said instructions to
i. select an analysis period, said analysis period comprising at least one trading session;
ii. select a first time interval in said trading session, said first time interval comprising security information, said security information comprising an opening price value, a closing price value, a high price value, a low price value, and share volume value;
iii. select a second time interval in said trading session, said second time interval comprising security information, said security information comprising an opening price value, a closing price value, a high price value, a low price value, and a share volume value;
iv. select a price interval value;
v. determine an inflection direction value;
vi. calculate an effective volume multiplier, if said inflection direction value is not equal to zero, said step of calculating an effective volume comprising the steps of:
A. calculating the effective volume multiplier as follows:
[(ABS(C′−C))+PI]/(H−L+PI),
B. if said inflection direction value is equal to zero, assigning zero as the effective volume multiplier;
wherein C′ equals said closing value of said first time interval, C equals said closing value of said second time interval, PI equals said selected price interval value, H equals the maximum value of said high price value of said second time interval and said closing value of said first time interval, L equals the minimum value of said low price value of said second time interval and said closing value of said first time interval; and
vii. multiply said effective volume multiplier by said share volume value to obtain said effective volume.

14. The system of claim 13 wherein said processor unit is operable to process said input and to use said instructions to determine an inflection direction value by assigning the inflection direction value as +1 if C>C′, as −1 if C<C′, and as 0 if C=C′.

15. The system of claim 13 wherein said processor is further operable to process said input and to use said instructions to
a. determine whether a time interval is the initial time interval in said trading session; and
b. select a subsequent time interval if said time interval is an initial time interval.

16. The system of claim 13 wherein said processor is further operable to process said input and to use said instructions to select a second time interval by selecting a time interval that is subsequent to said selected first time interval.

17. The system of claim 13 wherein said processor is further operable to process said user input and to use said instructions to:
a. determine whether said selected first time interval is the last time interval of said trading session; and
b. conclude said method if said selected first time interval is the last interval.

18. The system of claim 13 wherein said trend change is a price change.

19. The system of claim 13 wherein said processor is further operable to process said user input and to use said instructions to assign a separation volume value.

20. The system of claim 19 wherein said processor is further operable to process said input and to use said instructions to:
a. if said effective volume is not equal to zero, identify said effective volume as a large volume size if said effective volume is greater than or equal to the separation volume value; and
b. if said effective volume is not equal to zero, identify effective volume as a small volume size if said effective volume is less than the separation volume value.

21. The system of claim 20 wherein said separation volume value is such that the ratio of said large volume size to said small volume size is from about 0.42 to 1.

22. The system of claim 20, wherein said separation volume value is such that the ratio of said small volume size to said large volume size is from about 0.42 to 1.

23. The system of claim 19 wherein said analysis period comprises a plurality of trading sessions and said step of assigning a separation volume is separately calculated for each trading session in said plurality.

24. The system of claim 23 wherein said plurality of trading sessions comprises a plurality of consecutive trading sessions.

25. The system of any one of claims 12-22 further comprising an output means, said output means operable to display said effective volume responsible for said trend change.

26. The method of claim 8 further comprising calculating a Volume Flow comprising the steps of:
a. calculating Large Volume Size Volume Flow as follows:
LVS_VFᵢ=LVS_VFᵢ₋₁*inflection direction; and
b. calculating Small Volume Size Volume Flow as follows: SVS_VFᵢ=SVS_VFᵢ₋₁+SVS*inflection direction,

|wherein i=1, LVS_VFᵢ1=0, SVS_VFᵢ=0.
